(19) United States
(12) Patent Application Publication
(10) Pub. No.: US 2026/0356283 A1
(43) Pub. Date: Nov. 12, 2026

(54) Exterior Cladding Arrangement for a Motor Vehicle and Motor Vehicle Having Such an Exterior Cladding Arrangement

(71) Applicant: Mercedes-Benz Group AG, Stuttgart (DE)

(72) Inventors: Jens HUMPENOEDER, Ulm (DE); Annika BAEHNSCH, Stuttgart (DE)

(21) Appl. No.: 19/122,002

(22) PCT Filed: Sep. 27, 2023
(86) PCT No.: PCT/EP2023/076683

§ 371 Date: Apr. 17, 2025

(30) Foreign Application Priority Data
Oct. 31, 2022 (DE) 10 2022 004 060.3

(51) Int. Cl. B60Q 1/26; B60R 13/04

(52) U.S. Cl. CPC B60Q 1/2661; B60R 13/04

(57) ABSTRACT

An exterior cladding arrangement for a motor vehicle includes a cladding component with a front side and a trim part which has a plurality of decorative elements. The decorative elements are arranged in recesses of the cladding component. The decorative elements are connected to each other via connecting elements of the trim part. At least one of the decorative elements can be moved by a movement device from a first position into a second position where, in the second position, a visible side of the decorative element protrudes beyond the front side. In the first position, the visible side is shifted further towards the back side of the cladding component than in the second position. The visible side is opaque and a base body of the decorative element, which in the second position protrudes partially beyond the front side, is partially permeable to light from a lighting device.

### BACKGROUND AND SUMMARY OF THE INVENTION

The invention relates to an exterior cladding arrangement for a motor vehicle. Furthermore, the invention relates to a motor vehicle having at least one such exterior cladding arrangement.

DE 20 2020 104 697 U1 describes a cladding arrangement for a vehicle, in which a moulded component made of plastic has interruption areas. A translucent decorative component which is arranged behind the moulded component has several decorative sections. The decorative sections are uncovered in a visible area, in each case by one of the interruption areas. The decorative component has a translucent metal layer, wherein a lighting device is provided for illuminating the decorative component. A disadvantage here is the fact that it is necessary to provide a correspondingly high luminous intensity of the lighting device in order to illuminate the metal layer. Consequently, the illumination of the decorative component, including the metal layer of the decorative component, is associated with a correspondingly high energy expenditure. This high energy expenditure is unfavorable.

The object of the present invention is to provide an exterior cladding arrangement of the type mentioned at the beginning, in which improved visibility of the decorative elements can be achieved, and to provide a motor vehicle with such an exterior cladding arrangement.

The exterior cladding arrangement according to the invention for a motor vehicle comprises a cladding component which has a front side. The front side is facing towards the surroundings of the motor vehicle when the cladding component is installed in position in the motor vehicle. The exterior cladding arrangement comprises a trim part which is arranged on the cladding component and which has a plurality of decorative elements. The decorative elements are arranged in recesses which are made in the cladding component. The decorative elements are connected to each other via a plurality of connecting elements of the trim part, wherein the connecting elements are arranged on a back side of the cladding component opposite the front side. The exterior cladding arrangement comprises a movement device, by means of which at least one of the decorative elements can be moved from a first position into a second position. In the second position, a visible side of the at least one decorative element protrudes beyond the front side of the cladding component. In the first position, the visible side of the at least one decorative element is shifted further towards the back side of the cladding component than in the second position.

By means of the movement device, the at least one decorative element can thus be extended out of the cladding component. When the decorative element has been moved into the second position and thus extended, the visible side of the at least one decorative element is offset in relation to the front side of the cladding component, specifically offset towards the surroundings of the cladding component. Accordingly, in the second position, the visible side of the at least one decorative element protrudes beyond the front side of the cladding component. This means that the at least one decorative element is more visible than when the at least one decorative element is in the first position. Consequently, improved visibility of the decorative elements can be achieved with the exterior cladding arrangement comprising the movement device.

The improved visibility of the at least one decorative element, which is moved into the second position by means of the movement device, also ensures that the exterior cladding arrangement can be seen particularly well by an observer looking at the front of the cladding component from the surroundings. This is advantageous with regard to the fact that the visibility of the motor vehicle having the exterior cladding arrangement with the cladding component can also be increased in a simple manner.

The movement device can in particular be designed as an electromechanical and/or pneumatic and/or hydraulic actuator or comprise at least one such actuator.

According to the invention, it is furthermore provided that the visible side of the at least one decorative element is opaque, wherein a base body of the at least one decorative element is at least partially permeable to light from a lighting device of the exterior cladding arrangement. In the second position, the base body of the at least one decorative element protrudes at least partially beyond the front side of the cladding component. Consequently, by moving the at least one decorative element into the second position, it is possible to ensure that light provided during operation of the lighting device can escape into the surroundings via the base body, which is at least partially translucent.

However, the light does not need to illuminate the visible side of the decorative element, which is impermeable to light. Instead, the light can reach the surroundings unhindered via at least one side flank of the base body, wherein the at least one side flank is adjacent to the visible side. This has the advantage that the energy expenditure required to provide the light by means of the lighting device is kept particularly low.

Furthermore, the emission of light into the surroundings via the at least one side or side flank of the base body adjacent to the visible side is advantageous with regard to improved visibility of the at least one decorative element moved into the second position. This is because, particularly in the dark or at dusk, operating the lighting device and moving the at least one decorative element into the second position can ensure that the light that is emitted from the at least partially translucent base body of the decorative element into the surroundings is visible.

Since the visible side of the at least one decorative element is opaque, it is favourable for making the decorative elements more visible to operate the lighting device only when the at least one decorative element has been moved by means of the movement device into the second position, in which the base body protrudes at least partially or at least a little beyond the front side of the cladding component. This is because when the decorative element has been moved into the second position, the light from the lighting device can be coupled out into the surroundings in a particularly low-cost and energy-saving manner. This is advantageous, especially if the motor vehicle with the exterior cladding arrangement is an electric vehicle or a hybrid vehicle, in which the supply of electrical energy for operating the lighting device is naturally limited.

The base body can, for example, be made of a transparent or translucent material such as polycarbonate (PC) and/or polymethyl methacrylate (PMMA) and/or polypropylene (PP). The visible side of the decorative element can be formed by an opaque component of the decorative element, for example by a lacquer foil and/or a hot stamping foil and/or a lacquer or the like. Accordingly, the decorative element can be provided by back-injection moulding such a component or by subsequently applying the component to the base body, for example by hot stamping and/or painting or the like.

In particular, if all sides or side flanks of the base body adjacent to the visible side are permeable to the light from the lighting device and thus transparent or translucent, the light of the lighting device can be perceived very well when the at least one decorative element is moved into the second position. This is advantageous.

Preferably, the lighting device comprises a plurality of light sources, wherein a respective light source is assigned to the respective base body of the decorative element. This is also conducive to low energy consumption during operation of the lighting device. This is because the respective light source is arranged very directly where the light emitted by the light source during operation of the same is coupled into the base body of the decorative element.

Preferably, the exterior cladding arrangement comprises a control device which is designed to control the movement device. As a result, the at least one decorative element can be brought from the first position into the second position and back as required or depending on the situation.

Additionally or alternatively, the control device may be designed to control the lighting device. In this manner, the emission of light by means of the lighting device, which reaches the surroundings via the base body of the decorative element, can be adapted to respective situations and thus implemented in a particularly advantageous manner.

In particular, it may be provided that the control device activates the lighting device while the movement device moves the at least one decorative element from the first position to the second position. Additionally or alternatively, it may be provided that the control device activates the lighting device when the at least one decorative element is moved or brought into the second position by means of the movement device. This makes it particularly easy to see the light emitted from the base body into the surroundings.

The movement device can be designed to move the decorative elements individually from the first position to the second position. In this way, the visibility of the decorative elements can be improved very individually.

It is particularly efficient if the lighting device is designed to move at least one group of the decorative elements together from the first position to the second position. This makes it particularly easy to move a plurality of decorative elements together from the first position to the second position and back, this movement being able to be implemented by means of the movement device.

Preferably, the at least one group is provided by decorative elements arranged in a row. In this manner, it can be ensured that the decorative elements arranged next to each other in the preferably straight row are moved together or jointly from the first position to the second position. This is conducive to improved visibility of the decorative elements arranged in the row when the decorative elements are in the second position.

It can also be provided that groups of decorative elements arranged one after the other in respective rows can be moved from the first position to the second position and back by means of the movement device. This is also advantageous for improved visibility of the decorative elements moved into the second position.

Furthermore, it can be provided that the decorative elements belonging to a group are moved one after the other along the row from the first position into the second position, whereby each decorative element moved into the second position remains at least temporarily in this second position. In particular, the respective decorative element moved into the second position can remain in the second position until the remaining decorative elements of the same row have also been moved into the second position.

By extending the decorative elements along the row from the cladding component one after the other, a movement along the row can be expressed very well. This is advantageous for good visual perception of such a movement. A movement modelled by the successive extension is particularly conspicuous and therefore easy for an observer to perceive if the lighting device is also being operated, which couples the light into the respective base body of the decorative elements during operation.

Furthermore, it has been proved advantageous when the movement device is designed to move all decorative elements of the trim part together from the first position into the second position. This makes it particularly easy to actuate the decorative elements by extending them out of the cladding component. In particular, for this purpose, the trim part can have a sufficiently high inherent rigidity so that all decorative elements can be moved from the first position into the second position together with the trim part by means of the movement device.

Preferably, in the first position, the visible side of the at least one decorative element is flush with the front side of the cladding component. In this manner, it can be achieved that the decorative elements in the first position are integrated almost invisibly into a vehicle outer skin, which is provided in the motor vehicle by the cladding component and the trim part of the outer cladding arrangement.

However, it is also possible that in the first position, the visible side of the at least one decorative element is shifted, in particular slightly, towards the back side of the cladding component in relation to the front of the cladding component.

It is further conducive to a high degree of invisibility of the at least one decorative element in the first position of the decorative element if a color of the visible side of the at least one decorative element is the same color as the front side of the cladding component.

In particular, if the decorative elements are well concealed in the first position or are not or hardly recognizable to the observer looking at the cladding component from the surroundings, increasing the visibility of the decorative elements by moving them from the first position into the second position is advantageous in order to increase the visibility of the decorative elements.

However, even if a color of the visible side of the at least one decorative element is different from the color of the front side of the cladding component, extending the decorative elements from the cladding component, i.e., moving the decorative elements from the first position into the second position, contributes to the advantageously improved visibility of the decorative elements.

The motor vehicle according to the invention has at least one exterior cladding arrangement according to the invention. Different areas of use for the at least one exterior cladding arrangement are conceivable on the motor vehicle.

In particular, the cladding component of the at least one exterior cladding arrangement can be designed as a bumper cladding of the motor vehicle. In the region of at least one bumper of the motor vehicle, increased perceptibility of the decorative elements is of particular advantage, which can be achieved by moving the decorative elements from the first position into the second position, with the movement device causing this extension of the decorative elements. Additionally or alternatively, the cladding component of the at least one exterior cladding arrangement can be designed as a mudguard and/or a bonnet of the motor vehicle. Improving the visibility of the decorative elements by extending them out of the cladding component is also advantageous in these areas of use of the exterior cladding arrangement.

The advantages and preferred embodiments described for the exterior cladding arrangement according to the invention apply analogously to the motor vehicle according to the invention and vice versa.

Further advantages, features and details of the invention result from the following description of preferred exemplary embodiments and with reference to the drawings. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWINGS

FIG. 1 shows schematically a cladding component and a trim part of an exterior cladding arrangement for a motor vehicle;

FIG. 2 shows the trim part in an installation position, in which decorative elements of the trim part are arranged in recesses which are made in the cladding component;

FIG. 3, in a schematic side view, shows two of the decorative elements in a first position, in which a visible side of the decorative elements is flush with a front side of the cladding component;

FIG. 4, in a schematic side view, shows the decorative elements according to FIG. 3 in a second position, in which the decorative elements are extended out from the recesses and the visible side of the respective decorative element protrudes beyond the front side of the cladding component;

FIG. 5 shows schematically the emission of light via side flanks of base bodies of the decorative elements into the surroundings; and

FIG. 6 shows schematically a motor vehicle, in which the exterior cladding arrangement comprising the cladding component and the trim part can be or is used.

### DETAILED DESCRIPTION OF THE DRAWINGS

In the figures, identical or functionally identical elements are provided with the same reference numerals in each case.

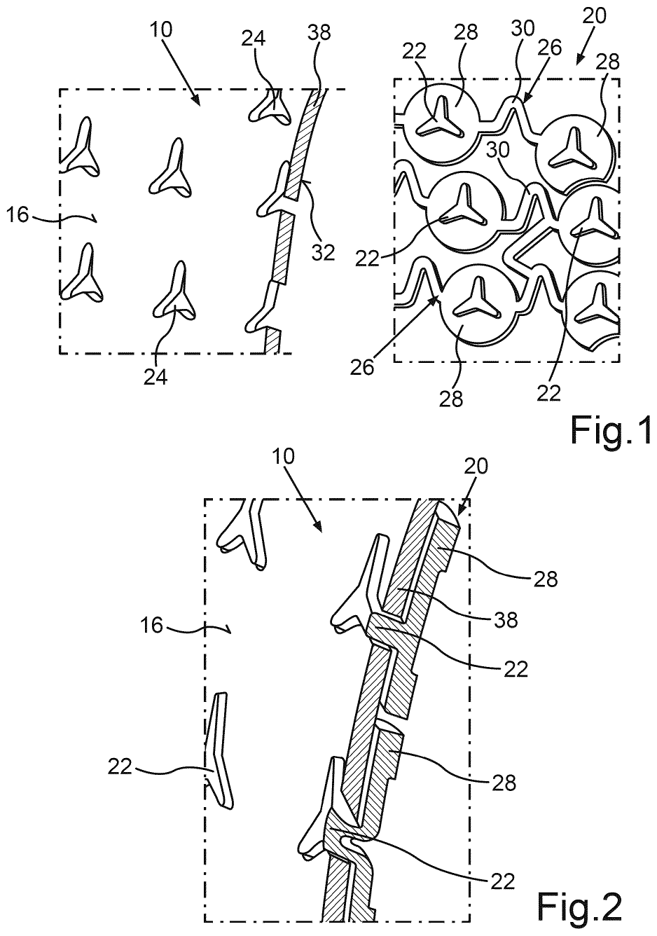

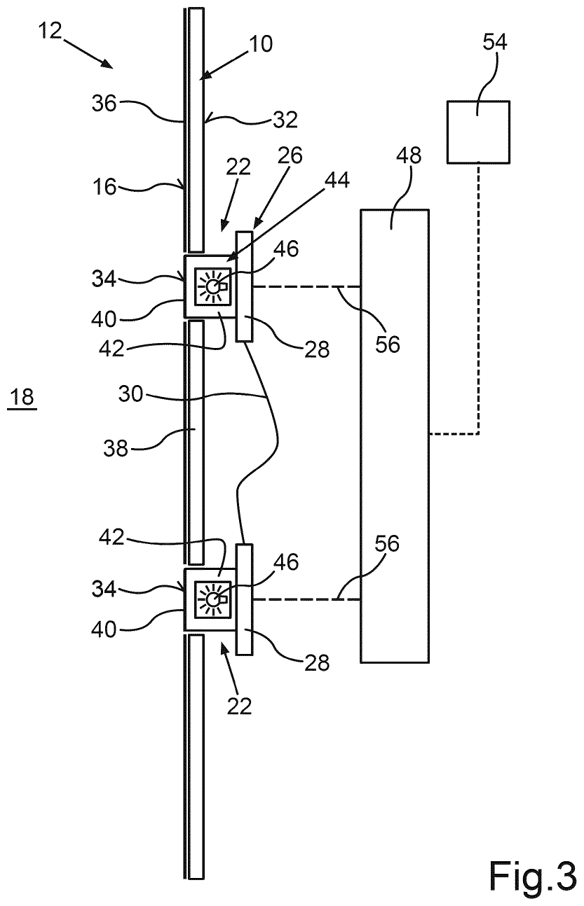

In FIG. 1, a cladding component 10 is shown in a schematic perspective view, which is part of an exterior cladding arrangement 12 for a motor vehicle 14 (see FIG. 6), shown schematically in FIG. 3. The cladding component 10 has a front side 16 which is facing towards the surroundings 18 of the motor vehicle 14 (see FIG. 6) and thus also the surroundings 18 of the exterior cladding arrangement 12 (see FIG. 3) when the cladding component 10 or rather the exterior cladding arrangement 12 is installed in the motor vehicle 14.

The exterior cladding arrangement 12 also comprises a trim part 20, shown in FIG. 1, which has a plurality of decorative elements 22. By way of example, the decorative elements 22 are represented as three-pointed stars in FIG. 1, wherein for clarity reasons, only some of these decorative elements 22 are provided with reference numerals in FIG. 1. Recesses 24 which are made in the cladding component 10 correspond to the decorative elements 22. In other words, in the present case, an outer contour of the respective decorative element 22 preferably corresponds to an inner contour of the respective recess 24. This enables one of the decorative elements 22 to be arranged in each case in one of the respective recesses 24, which are made in the cladding component 10.

The presently inherently rigid trim part 20 has a plurality of connecting elements 26 via which the decorative elements 22 are connected to each other. Accordingly, the trim part 20 is designed in the form of an inherently rigid decorative grid, whereby it is ensured that the decorative elements 22 are held in an arrangement corresponding to the respective recess 24 when the decorative elements 22 are introduced into the corresponding recesses 24. The connecting elements 26 therefore add inherent rigidity to the trim part 20, in order to position the decorative elements 22 in the region of the recesses 24.

In particular, when the decorative elements 22, as shown in the present case by way of example, are designed as filigree structures, for instance in the form of three-pointed stars, it is advantageous when the connecting elements 26 comprise support regions 28 which, according to the schematic representation in FIG. 1, are designed as plate-shaped and presently round carrier parts for the decorative elements 22. Furthermore, the connecting elements 26 of the trim part 20 according to FIG. 1 comprise a plurality of webs 30, by means of which in the present case the support regions 28 are coupled to each other.

The connecting elements 26, which in the present case comprise the support regions 28 and the webs 30, provide an inherently rigid grid structure of the trim part 20 formed as a decorative grid, by means of which structure the decorative elements 22 are held in a position which corresponds to the position of the recesses 24 made in the cladding component 10.

The recesses 24 can be produced directly at the same time as the production of the cladding component 10. This is very simple in particular when the cladding component 10 is formed from a plastic, for instance by injection moulding. This is because the recesses 24 can be produced directly at the same time as the injection moulding of the cladding component 10.

Alternatively, it is possible to make the recesses 24 in the cladding component 10 retrospectively by mechanical machining, for instance by punching and/or laser cutting and/or waterjet cutting or similar. Corresponding separating methods can then also be used when the cladding component 10 is formed from a metal.

FIG. 2 shows a detail of the arrangement of the trim part 20 on the cladding component 10, in which the decorative elements 22 have been introduced into the recesses 24 made in the cladding component 10. Accordingly, the connecting elements 26, of which only the support regions 28 can be seen in FIG. 2, are arranged on a back side 32 of the cladding component 10 opposite the front side 16.

In FIG. 3 it is schematically shown how the respective decorative elements 22 can be arranged relative to the cladding component 10. Accordingly, in FIG. 3, the decorative elements 22 are shown brought or moved into a first position in which a visible side 34 of the respective decorative element 22 is flush with the front side 16 of the cladding component 10.

The front side 16 of the cladding component 10 can be formed by at least one layer of paint 36, which is applied to a carrier body 38 of the cladding component 10. In FIG. 1 and FIG. 2, the paint layer 36 or similar coating of the carrier body 38 is not shown in more detail for reasons of clarity.

In a similar manner, the visible side 34 of the decorative elements 22 can be provided by a film 40 and/or a lacquer or the like. For example, the film 40 can be applied to a base body 42 of the respective decorative element 22. It is also possible to provide the decorative element 22 by back-injection moulding the film 40, for example in the form of a lacquer film, with a material by means of which the base body 42 of the decorative element 22 is provided. Similarly, the visible side 34 of the decorative element 22 can be provided by providing the base body 42 with at least one layer of paint or the like, i.e., by painting it.

In the present case, the visible side 34 of the decorative elements 22 is opaque. This can be achieved, for example, by the film 40 or similar coating of the base body 42 being formed from an opaque material. In contrast, in the present case, the base body 42 of the respective decorative element 22 is formed from a translucent material, for example polycarbonate (PC), polymethyl methacrylate (PMMA) or polypropylene (PP).

According to FIG. 3, the exterior cladding arrangement 12 has a lighting device 44, which according to FIG. 3 comprises a plurality of light sources 46. In the present case, a respective light source 46 is assigned to the respective base body 42. For example, the light sources 46 of the lighting device 44 can be designed as light-emitting diodes.

In the first position of the decorative elements 22 shown in FIG. 3, it is not expedient to operate the lighting device 44 or to activate the light sources 46. This is because, in the first position of the decorative elements 22, the opaque visible side 34 of the decorative elements 22 prevents light emitted by the light sources 46 from reaching the surroundings 18 of the exterior cladding arrangement 12 or the motor vehicle 14 (see FIG. 6). Therefore, the lighting device 44 is preferably not in operation when the decorative elements 22 are in the first position shown in FIG. 3.

In particular, if a color of the visible side 34 is the same as a color of the front side 16, in the first position shown in FIG. 3, the decorative elements 22 are integrated almost invisibly into the outer skin of the motor vehicle 14.

However, it is also possible, for example by using corresponding films 40 and/or paints or the like, to give the decorative elements 22 a different color on their visible sides 34 than the cladding component 10 has on the front side 16. For example, the decorative elements 22 can have a chrome look or the like on the visible side 34. In this case too, however, it is preferable for the visible sides 34 of the decorative elements 22 to be opaque.

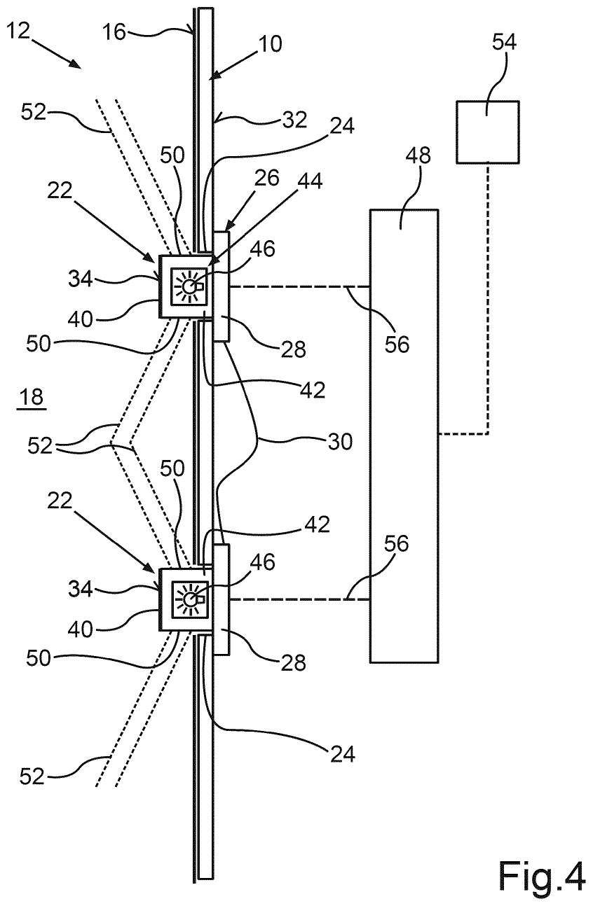

According to FIG. 3, the exterior cladding arrangement 12 comprises a movement device 48, which is only shown in highly schematic form in FIG. 4. The movement device 48 is designed to move the decorative elements 22 from the first position shown in FIG. 3 into a second position shown in FIG. 4. In the second position of the decorative elements 22 shown in FIG. 4, the visible side 34 protrudes beyond the front side 16 of the cladding component 10.

Accordingly, side flanks 50 of the base body 42 of the decorative elements 22, which is formed from the translucent material in the present case, are exposed to a certain extent. This is because in the area of these translucent side flanks 50, the base body 42 protrudes beyond the front side 16 of the cladding component 10. Accordingly, the light emitted by the light sources 46 or coupled into the respective base body 42 can exit into the environment 18 via these side flanks 50 or lateral outer walls or similar sides of the base body 42 adjacent to the visible side 34. Corresponding light rays 52 are shown schematically in FIG. 4, wherein for reasons of clarity only some of the light rays 52 are provided with reference numerals.

The decorative elements 22 designed in the present case for emitting light can thus be easily well concealed by moving the decorative elements 22 into the first position (see FIG. 3). The movement of the decorative elements 22 from the first position into the second position (see FIG. 4) and back is achieved by means of the movement device 48 shown schematically in FIG. 3 and FIG. 4.

When the light sources 46 are switched off and the decorative elements 22 are also moved into the first position (see FIG. 3), the decorative elements 22 are integrated almost invisibly into the outer skin of the motor vehicle 14, which is provided by the exterior cladding arrangement 12. If, on the other hand, the light sources 46 are switched on and at the same time the decorative elements 22 are extended so that the visible sides 34 of the decorative elements 22 protrude beyond the front side 16 of the cladding component 10, the light emitted from the respective base body 42 of the decorative elements 22 can be detected very well.

In addition, the visible side 34 of the decorative elements 22 does not need to be illuminated in order to ensure that the decorative elements 22 are visible. And by extending the decorative elements 22 in such a way that the base bodies 42 protrude in some areas from the respective recess 24 in the direction of the front side 16 of the cladding component 10, particularly good visibility of the decorative elements 22 is ensured. This ensures that the motor vehicle 14 (see FIG. 6) is also clearly visible. This is advantageous for safety reasons, for example, especially at night or at dusk.

FIG. 3 and FIG. 4 schematically show a control device 54 of the exterior cladding arrangement 12, which is preferably designed to control the movement device 48 and the lighting device 44. Accordingly, the control device 54 can very easily cause the light sources 46 to be switched on while the decorative elements 22 are being moved from the first position shown in FIG. 3 into the second position shown in FIG. 4 and/or when the decorative elements 22 are in the second position shown in FIG. 4.

Kinematic elements 56 of the movement device 48 are shown in FIG. 3 and FIG. 4 in highly schematic form. For example, the kinematic elements 56 can be positioned at the respective support regions 28 of the connecting elements 26 (see FIG. 1). In particular in this way, it can be achieved that the decorative elements 22 are extended individually, i.e., moved individually from the first position shown in FIG. 3 into the second position shown in FIG. 4.

However, it may also be provided that respective groups of the decorative elements 22 are moved together from the first position into the second position by means of suitable kinematic elements 56 of the movement device 48. For example, the decorative elements 22 can be arranged in the decorative grid in vertical and/or horizontal rows, as schematically illustrated in FIG. 1. Accordingly, by means of the movement device 48, such a group, for example, such a row of decorative elements 22 arranged next to one another can be moved from the first position shown in FIG. 3 into the second position shown in FIG. 4 and back.

In the present case, in the first position, in which the decorative elements 22 are concealed as far as possible (see FIG. 3), the decorative elements 22 of the trim part 20 are arranged flush with the front side 16 of the cladding component 10. For light staging (see FIG. 4), the decorative elements 22 can be extended by means of the movement device 48, and the light is emitted into the surroundings 18 via the side flanks 50 of the base bodies 42 of the decorative elements 22 (see FIG. 4).

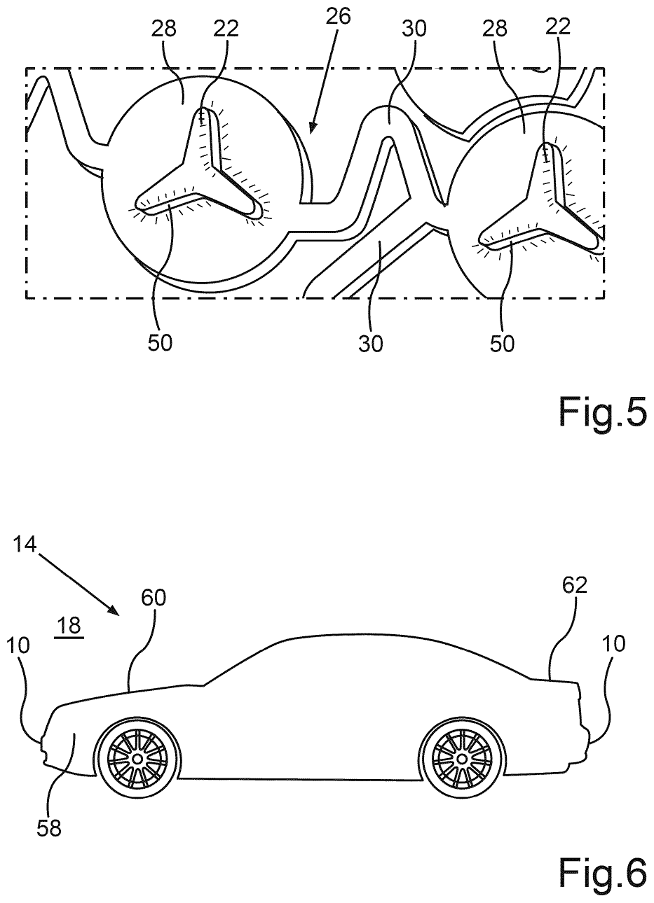

FIG. 5 shows schematically how the light from the lighting device 44 can be emitted into the surroundings 18 via the side flanks 50 of the respective base bodies 42 of the decorative elements 22. For reasons of clarity, the cladding component 10 is not shown separately in FIG. 5.

According to FIG. 6, the cladding component 10 of the exterior cladding arrangement 12 can, for example, be designed as a bumper cladding of the motor vehicle 14, for example as a front-side bumper cladding or as a rear-side bumper cladding. However, it is also possible to arrange the exterior cladding arrangement 12 in the region of a mudguard 58 and/or a bonnet 60 and/or a rear lid 62 of the motor vehicle 14.

Overall, the examples show how the exterior cladding arrangement 12 can provide a concealed light function in which the light emitted from the decorative elements 22 and thus also the decorative elements 22 themselves are clearly visible to an observer in an advantageous manner.

1.-8. (canceled)

9. An exterior cladding arrangement (12) for a motor vehicle (14), comprising:
a cladding component (10) which has a front side (16), wherein the front side (16) is facing towards surroundings (18) of the motor vehicle (14) when the cladding component (10) is installed in position in the motor vehicle (14);
a trim part (20), wherein the trim part (20) is disposed on the cladding component (10) and has a plurality of decorative elements (22), wherein the plurality of decorative elements (22) are disposed in respective recesses (24) of the cladding component (10), wherein the plurality of decorative elements (22) are connected to each other via a plurality of connecting elements (26) of the trim part (20), and wherein the plurality of connecting elements (26) are disposed on a back side (32) of the cladding component (10) which is opposite the front side (16);
a movement device (48) via which at least one of the plurality of decorative elements (22) is movable from a first position into a second position, wherein, in the second position, a visible side (34) of the at least one of the plurality of decorative element (22) protrudes beyond the front side (16) of the cladding component (10) and wherein, in the first position, the visible side (34) of the at least one of the plurality of decorative element (22) is shifted further towards the back side (32) of the cladding component (10) than in the second position; and
a lighting device (44);
wherein the visible side (34) of the at least one of the plurality of decorative element (22) is opaque, wherein a base body (42) of the at least one of the plurality of decorative element (22), which in the second position protrudes at least partially beyond the front side (16) of the cladding component (10), is at least partially permeable to light from the lighting device (44).

10. The exterior cladding arrangement (12) according to claim 9, wherein the lighting device (44) comprises a plurality of light sources (46) and wherein a respective light source (46) of the plurality of light sources (46) is assigned to a respective base body (42) of the plurality of decorative element (22).

11. The exterior cladding arrangement (12) according to claim 9, further comprising a control device (54) which is configured to control the movement device (48) and/or the lighting device (44).

12. The exterior cladding arrangement (12) according to claim 9, wherein the movement device (48) is configured to move at least one group of the plurality of decorative elements (22) together from the first position into the second position and wherein the at least one group of the plurality of decorative elements (22) are decorative elements (22) of the plurality of decorative elements (22) that are arranged in a row.

13. The exterior cladding arrangement (12) according to claim 9, wherein the movement device (48) is configured to move all of the plurality of decorative elements (22) of the trim part (20) together from the first position into the second position.

14. The exterior cladding arrangement (12) according to claim 9, wherein, in the first position, the visible side (34) of the at least one of the plurality of decorative elements (22) is flush with the front side (16) of the cladding component (10).

15. The exterior cladding arrangement (12) according to claim 9, wherein a color of the visible side (34) of the at least one of the plurality of decorative elements (22) and a color of the front side (16) of the cladding component (10) are a same color.

16. A motor vehicle, comprising:
the exterior cladding arrangement (12) according to claim 9.
